(19) United States
(12) Patent Application Publication
(10) Pub. No.: US 2007/0116963 A1
(43) Pub. Date: May 24, 2007

(54) Highly durable spring and method for coating same

(75) Inventor: Takayuki Sakakibara, Nagoya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Chuo Hatsujo Kabushiki Kaisha, Nagoay-shi (JP); Rock Paint co., Ltd., Osaka-shi (JP)

(21) Appl. No.: 10/581,972

(22) PCT Filed: Dec. 7, 2004
(86) PCT No.: PCT/JP04/18549

§ 371 Date: Dec. 26, 2006

(30) Foreign Application Priority Data
Dec. 9, 2003 (JP) 2003-410552

(51) Int. Cl. B05D 1/12; B05D 3/02; B05D 7/00; B32B 27/38

(52) U.S. Cl. 428/414; 427/180; 427/402; 427/384; 427/314; 428/416; 428/482

(57) ABSTRACT

A spring with high durability, which is excellent in corrosion resistance and chipping resistance, is provided. And the coating method for forming such a spring is provided. Dual-layer coating films composed of an undercoat layer and a topcoat layer are formed on a surface of the spring to obtain the spring with high durability, which is excellent in corrosion resistance and chipping resistance. The coating method includes an undercoating step of making an epoxy resin powder coating which contains 75 wt % or more of zinc adhere to the surface of the spring, a topcoating step of making an epoxy polyester resin powder coating adhere to an undercoat film composed of the epoxy resin powder coating, and a baking step of baking the undercoat film and the epoxy polyester resin powder coating adhered thereto.

### TECHNICAL FIELD

The present invention relates to a spring with high durability, which is excellent in corrosion resistance and chipping resistance, and a method of coating the same.

### BACKGROUND ART

Various kinds of suspension springs have been used in motor vehicles, trains, etc. Many of these suspension springs are made of steel, and coating adapted to impart corrosion resistance thereto has been normally applied to surfaces thereof. When the motor vehicles, etc. are running, pebbles and gravels spattered by their wheels strike the suspension springs to cause peeling of coating films, that is the so-called chipping, due to striking impact. When uncoated surfaces of the suspension springs become exposed due to chipping, rust is formed thereon. Accordingly, high chipping resistance as well as high corrosion resistance are required to coating of the suspension springs.

On the other hand, coating composed of a plurality of layers has been applied to bodies of motor vehicles, considering the corrosion resistance, chipping resistance, appearance of bodies, etc. The bodies of the motor vehicles and the suspension springs, however, differ from each other in composition, strength, etc. And, great distortions are generated in the suspension springs due to deformations thereof. Consequently, the suspension springs require a special coating exhibiting corrosion resistance and chipping resistance.

From these viewpoints, U.S. Pat. No. 5,981,086, ex. discloses the technique of imparting corrosion resistance and chipping resistance to a high-tensile steel by applying a dual-layer coating including a first layer composed of a thermosetting epoxy which contains zinc with a predetermined ratio, and a second layer composed of an ethylene/acrylic copolymer.

With the coating method disclosed in U.S. Pat. No. 5,981,086, however, sufficient corrosion resistance and chipping resistance cannot be obtained. Consequently, further improvement of both characteristics is desired upon the coating of the suspension springs.

### DISCLOSURE OF INVENTION

The present invention has been made after consideration of these circumstances, and has an object of providing a spring with high durability, which is excellent in corrosion resistance and chipping resistance. In addition, the present invention has an object of providing a coating method for realizing such a spring.

Namely, the spring with high durability in accordance with the present invention is characterized in that coating of two layers of an undercoat layer composed of an epoxy resin powder coating which contains 75 wt % or more of zinc, and a topcoat layer formed on the undercoat layer and composed of an epoxy polyester resin power coating, is applied thereto.

The spring with high durability in accordance with the present invention is coated with a dual-layer coating film composed of the undercoat layer and the topcoat layer. Therefore, if pebbles and gravel strike the spring, the coating film is difficult to peel from the spring to prevent the exposure of a surface of the spring. Namely, the chipping resistance of the coating film is high so that corrosion of the spring is restrained to improve the durability of the spring. And the undercoat layer is composed of an epoxy resin power coating and the topcoat layer is composed of an epoxy polyester resin power coating. Since both layers include resins of the same kind,.the adhesion between two layers is high. Therefore, if a great distortion peculiar to the spring is generated, two layers are difficult to peel off each other, and consequently, following characteristics against the deformation of the spring are excellent. Furthermore, the zinc content in the undercoat layer is as high as 75 wt % or more. Accordingly, the rust preventing effect by virtue of zinc is high. Consequently, the spring with high durability in accordance with the present invention is excellent in corrosion resistance.

And the method of coating a spring with high durability in accordance with the present invention is characterized in that an undercoating step of applying an epoxy resin power coating which contains 75 wt % or more of zinc on a surface of the spring, a topcoating step of making an epoxy polyester resin power coating adhere to an undercoat film composed of the epoxy resin power coating, and a baking step of baking the undercoat film and the adhered epoxy polyester resin power coating are included.

In accordance with the coating method of the present invention, the spring with high durability in accordance with the present invention can be readily produced. Namely, with the coating method of the present invention, in the undercoating step, an epoxy resin powder coating adapted to form the undercoat layer is made to adhere, and in the topcoating step, an epoxy polyester resin powder coating adapted to form the topcoat layer is made to adhere. By heating the coatings which have adhered in respective steps, they are fused and cured to form respective layers.

The coating method of the present invention includes a baking step after the topcoating step. The curing conditions of the coatings are, however, not limited specifically. Namely, the curing condition such as 2 coating 2 baking of heating adhered coatings for curing after both the undercoating step and the topcoating step, and 2 coating 1 baking of heating adhered coatings for curing only after the topcoating step can be arbitrarily selected. Therefore, “undercoat film” in the respective topcoating step and baking step of the present coating method can take various states depending on the heating conditions after-the undercoating step. Namely, as explained later in detail, “undercoat film” may take any state in which the epoxy resin powder coating remains adhered thereto, is under curing or has been cured.

And with the coating method in accordance with the present invention, a powder coating containing no solvent is used so as not to cause environmental problems due to volatilization of solvent, waste water containing solvent, etc. In addition, since the coating does not contain any organic solvent, the safety of the coating work is high.

### BRIEF DESCRIPTION OF DRAWINGS

FIG. 1 is a graph showing the relation between the thickness of a coating film and the peel strength thereof.

FIG. 2 is a graph showing the relation between the thickness of a coating film and the shear strength thereof.

FIG. 3 is a graph showing the peel strength and the shear strength per unit thickness of the coating film.

### BEST MODE FOR CARRYING OUT THE INVENTION

Hereinafter, the spring with high durability and the method of coating the same in accordance with the present invention will be explained in detail.

(Spring with High Durability)

Dual-layer coating consisting of an undercoat layer which is formed of an epoxy resin powder coating containing 75 wt % or more of zinc, and a topcoat layer which is formed on the undercoat layer and composed of an epoxy polyester resin power coating is applied on the spring with high durability in accordance with the present invention.

In the spring with high durability in accordance with the present invention, the configuration of the spring to be coated is not limited specifically. Springs with various configurations such as coil springs, leaf springs, torsion bars, etc. can be used. The material for the spring is not limited specifically, provided that it is composed of a metal, and examples of the preferred material include spring steel which has been normally used for the springs, etc. In this case, the spring steel, etc. may be subjected to shot peening, etc. to adjust the surface roughness, after hot formed or cold formed.

And it is desirable to previously form a film composed of phosphate such as zinc phosphate, iron phosphate, etc. on the surface of the spring, which is adapted to be coated. Where dual-layer coating films are formed on the phosphate film, the corrosion resistance and the adhesion of the coating films are further improved. In this case, it is effective that the phosphate film covers 80% or more of the surface area (100%) of the spring to be coated. In particular, where phosphate is zinc phosphate, the corrosion resistance is further improved.

The film weight of the formed phosphate film is not limited specifically. Normally, to impart corrosion resistance by the phosphate film, the film weight of about 1.8 to 2.3 g/m² has been needed. On the other hand, as the film weight decreases, the adhesion of the coating film increases. With the spring with high durability in accordance with the present invention, sufficient corrosion resistance is obtained by virtue of the formed dual-layer coating film. Therefore, where the phosphate film is formed, the film weight may be determined to 2.2 g/m or less in view of the adhesion thereof. The film weight is obtained by measuring the weight of the formed film, and alternatively, where the film is formed by the spray method, the film weight may be obtained by converting from the outlet amount of a spray gun.

For example, crystals of zinc phosphate in the phosphate film is composed of Zn₃(PO₄)₂.4H₂O (orthorhombic) and Zn₂Fe(PO₄)₂.4H₂O (monoclinic). The configuration and dimensions of these phosphate crystals affect the corrosion resistance and the adhesion of the coating film. In order to further improve the corrosion resistance and adhesion of the coating film, it is desirable that the crystal configuration of the phosphate is similar to a spherical configuration, and it is preferable that the average diameter of each crystal is 3 μm or less. In this case, the average diameter of the phosphate crystals may be measured by observing the phosphate film with the scanning electron microscope (SEM), etc. In the present specification, the average diameter of the major axis of each crystal observed with SEM is adopted as the average diameter.

In summary, it is preferable that in the spring with high durability in accordance with the present invention, a phosphate film is formed under the undercoat layer, the film weight of the phosphate film is 2.2 g/m² or less and the average diameter of the phosphate crystal is 3 μm or less.

The undercoat layer in the spring with high durability in accordance with the present invention is formed of an epoxy resin powder coating which contains zinc and an epoxy resin. The zinc content in the epoxy resin powder coating is 75 wt % or more to 100 wt % of the total weight of coating.

Examples of the epoxy resin used in the present invention include bisphenol A type epoxy resin, bisphenol F type epoxy resin, crystalline epoxy resin, etc. One of these epoxy resins may be used alone, or a mixture of two or more epoxy resins may be used. In the epoxy resin powder coating, it is desirable that the epoxy equivalent weight of the epoxy resin is 500 or more and 2500 or less. Where the epoxy equivalent weight is less than 500, the epoxy resin is in a liquid state so as not to be suited to the preparation of the present epoxy resin powder coating. On the other hand, when the epoxy equivalent weight exceeds 2500, the melt viscosity increases so as not to be suited to the preparation of the present epoxy resin powder coating.

The epoxy resin powder coating contains a curing agent which is normally used in powder coating as the coating film forming component, in addition to the above-described epoxy resins and zinc. Examples of the curing agent include aromatic amine, acid anhydride, dicyandiamide, derivative of organic acid dihydrazide, phenol resin, etc.

In addition, it is desirable that the epoxy resin powder coating contains block isocyanate which dissociates with heat. It is desirable that the block isocyanate content is 0.2 wt % or more and 5 wt % or less to 100 wt % of the total weight of the coating.

Typical examples of the polyisocyanate compound composing block isocyanate include diisocyanate such as isophorone diisocyanate, hexamethylene diisocyanates (HDI), hydrofined dipheyl methane diisocyanate, tolylene diisocyanate (TDI), etc., isocyanurate derived from these diisocyanates, and polyisocyanate modified with polyol. In particular, it is preferable to use isophorone diisocyanate derivative in view of the weather resistance and blocking resistance.

Examples of the blocking agent include various phenols such as phenol, cresol, etc., caprolactams, oximes, acetylacetone, or aliphatic alcohols, etc. It is preferable to use ε-caprolactam, methyl ethyl ketoxime, acetyl acetone in view of the dissociation temperature and the storage properties. It is especially preferable to use ε-caprolactam thereamong.

The epoxy resin powder coating may contain various additives as required in addition to the above materials. Examples of the additives include a surface adjusting agent adapted to adjust the surface tension of coating, an oxidant inhibitor for resin, an antistatic agent, fire retardant, etc.

The thickness of the undercoat layer in the spring with high durability in accordance with the present invention is not limited specifically. It is desirable that the thickness of the undercoat layer is 50 μm or more from the viewpoint of imparting sufficient corrosion resistance thereto. It is more preferable that the thickness is 60 μm or more. The method of forming the undercoat layer will be explained in the following explanation of the coating method.

The topcoat layer of the spring with high durability in accordance with the present invention is formed of an epoxy polyester resin powder coating which contains an epoxy resin and a polyester resin. One or more of the above-described epoxy resins may be used arbitrarily as the epoxy resin in the present coating. In this case, the same kind of resin as the epoxy resin composing the undercoat layer may be used, and alternatively, a different kind of resin may be used. In the present coating, it is desirable to use the epoxy resin of which the epoxy equivalent weight is 500 or more and 2000 or less. Where the epoxy equivalent weight is less than 500, problems such as blocking of powder coating, lowering of the flexibility of the coating film, etc. may be caused. And where the epoxy equivalent weight exceeds 2000, the melting and flowing properties of the powder coating may lower to cause the problems such as the faulty finishing of the coating film, lowering of the moisture resistance and heat resistance thereof, etc.

Examples of the polyester resins in the present coating include the resins obtained by interchange and polycondensation reaction of alcohols such as ethylene glycol, diethylene glycol, triethylene glycol, propanediol, butanediol, pentanediol, hexanediol, etc. and carboxylic acids such as terephthalic acid, maleic acid, isophthalic acid, succinic acid, adipic acid, sebacic acid, etc. One of these resins may be used alone, or a mixture of two or more thereof may be used.

The epoxy polyester resin powder coating is cured with the reaction of the epoxy resin and the polyester resin. Namely, the epoxy resin is a main resin, whereas the polyester resin acts as a curing agent. The composition ratio of the epoxy resin and the polyester resin is not limited specifically, but it is desirable to be determined to 1:1, ex. in equivalent weight ratio.

And it is desirable that the epoxy polyester resin powder coating contains various pigments such as a color pigment, extender pigment, etc. Examples of the color pigment include an inorganic type pigment such as carbon black, titanium dioxide, colcothar, ocher, etc., an organic type pigment such as quinacridone red, phthalocyanine blue, benzidine yellow, etc. And examples of the extender pigment include calcium carbonate, magnesium carbonate, talc, silica, barium sulfate, etc. In particular, the extender pigment is important, because it affects the mechanical properties of the coating film. For example, if the diameter of particles composing the extender pigment is small, the mechanical properties such as flexing properties of the coating film are improved, and consequently, the chipping resistance is improved. For example, where calcium carbonate is used as the extender pigment, it is desirable to determine the average particle diameter thereof to about 0.5 μm. And the impact resistance, etc. of the coating film change with the configuration of the particles, such as a scaled configuration, irregular configuration, needle-shaped configuration, etc. From the viewpoint of improving the chipping resistance, it is desirable to use the extender pigment with a needle-shaped or irregular configuration.

The pigment content is not limited specifically, but from the viewpoint of the hiding properties, ex., it is desirable that the pigment content is 2 wt % or more to 100 wt % of the total weight of the coating. On the other hand, considering the dispersing properties of the pigment, it is desirable that the pigment content is 60 wt % or less to 100 wt % of the total weight of the coating.

The epoxy polyester resin powder coating may contain various additives, as required, in addition to the above-described materials. Examples of the additives include a surface adjusting agent, ultraviolet-ray absorbing agent, oxidant inhibitor, antistatic agent, fire retardant, etc.

The thickness of the topcoat layer in the spring with high durability in accordance with the present invention is not limited specifically. But, from the viewpoint of improvement of the chipping resistance, it is desirable that the thickness of the topcoat layer is 200 μm or more. It is more preferable that the thickness of the topcoat layer is 400 μm or more. On the other hand, considering the following properties on the deformation of the spring, it is desirable that the thickness of the topcoat layer is 1200 μm or less. The method of forming the topcoat layer will be described in the following explanation of the coating method. <Coating Method of Spring with High Durability>

The coating method of the spring with high durability in accordance with the present invention includes an undercoating step, a topcoating step and a baking step. Hereinafter, each step will be explained in order.

(1) Undercoating Step

The present step is the step of making an epoxy resin powder coating containing 75 wt % or more of zinc adhere to a surface of a spring. The configuration, material, etc. of the spring to be coated are not limited specifically, and correspond to the above-described spring with high durability in accordance with the present invention. And the term “a surface of a spring” denotes not only an uncoated surface of a spring but also a surface of a film of phosphate such as zinc phosphate, iron phosphate, etc. where it is formed on the uncoated surface of the spring. In order to further improve the corrosion resistance and the adhesion of the coating film, it is desirable to previously form the phosphate film. In this case, the coating method of the present invention may include a pretreating step of previously forming the phosphate film on the uncoated surface of the spring, prior to the present step.

The formation of the phosphate film in the pretreating step may be carried out in a well known method. For example, the dipping method of dipping the spring in a bath of a solution of phosphate, the spraying method of spraying a solution of phosphate on the spring with a spray gun, etc. or other method will do. And the film weight of the formed phosphate film, the kind, the crystal configuration, etc. of phosphate correspond to the above-described spring with high durability in accordance with the present invention.

The epoxy resin powder coating for use in the present step is the same as explained for the above-described spring with high durability in accordance with the present invention. Namely, it is desirable that the epoxy resin powder coating contains 75 wt % or more of zinc, an epoxy resin and at least one material selected from predetermined curing agents and block isocyanate. In the present step, the epoxy resin powder coating may be made to adhere to the surface of the spring with a normally available method for powder coating, such as the electrostatic coating method, the electrostatic fluidization dipping method, the fluidization dipping method, etc.

(2) Topcoating Step

The present step is the step of making an epoxy polyester resin powder coating adhere to the undercoat film composed of the epoxy resin powder coating. As described above, the “undercoat film” to which the epoxy polyester resin powder coating is made to adhere in the present step can take various states depending on the heating carried or not after the undercoating step as well as the heating degree. Namely, where the step of heating the epoxy resin powder coating adhered to complete curing is included between the undercoating step and the present step (2 coating 2 baking), “undercoat film” becomes the film in which the epoxy resin powder coating is cured. And where an intermediate heating step of heating the epoxy resin powder coating adhered at a relatively low temperature to make curing proceed is included between the undercoating step and the present step (2 coating 1.5 baking), “undercoat film” becomes the film in which the epoxy resin powder coating is on the way of being cured ( film in a semi-cured state). On the other hand, where the present step is carried out without heating after the undercoating step (2 coating 1 baking), “undercoat film” becomes the film in which the epoxy resin powder coating remains adhered thereto.

The epoxy polyester resin powder coating for use in the present step is the same as explained for the above-described spring with high durability in accordance with the present invention. Namely, it is desirable that the epoxy polyester resin powder coating contains a predetermined pigment in addition to an epoxy resin and a polyester resin. In the present step, the epoxy polyester resin powder coating may be made to adhere to the undercoat film with the electrostatic coating method, the electrostatic fluidization dipping method, the fluidization dipping method, etc., similarly to the undercoating step.

(3) Baking Step

The present step is the step of baking the undercoat film and the epoxy polyester resin powder coating adhered thereto. The “undercoat film” in the present step can also take various states, as disclosed in the above described topcoating step. By carrying out the present step, the undercoat layer and the topcoat layer are formed.

The baking temperature is not limited specifically, but the temperature of 160° C. or above and 220° C. or below will do. The baking time of about 20 minutes will do. And baking may be carried out with normally available electric ovens, angled ovens, etc.

From the viewpoint of further improving the adhesion of the coating films, the present coating method can be carried out by the method which includes a preheating step of preheating a spring to 70° C. or above and 180° C. or below, prior to the undercoating step, and an intermediate heating step of heating the epoxy resin powder coating adhered at a temperature of 90° C. or above and 180° C. or below, between the undercoating step and the topcoating step, and in which the baking step is carried out at a temperature of 160° C. or above and 220° C. or below (2 coating 1.5 baking).

In the present method, the curing of the epoxy resin powder coating is made to proceed to some degree by heating or using residual heat, after the adhering of the epoxy resin powder coating to the preheated surface of the spring. Next, the epoxy polyester resin powder coating is made to adhere, and is baked. Namely, in the baking step, two kinds of coatings are not cured at once, but after the curing of the epoxy resin powder coating is made to proceed to some degree previously, baking is carried out at last. With this method, sufficient adhesion between layers can be obtained in the case that the formed undercoat layer and topcoat layer are thick. Where the above-described pretreating step is carried out prior to the undercoating step, the preheating step may be carried out after the pretreating step.

The thickness of each of the undercoat layer and the topcoat layer which are formed with the present coating method is not limited specifically. As described above, from the viewpoint of imparting sufficient corrosion resistance, it is desirable that the thickness of the undercoat layer is 50 μm or more. And in order to further improve the chipping resistance, it is desirable that the thickness of the topcoat layer is 200 μm or more.

In summary, in the coating method of the present invention, the preferred embodiment thereof includes a pretreating step of previously forming a phosphate film on an uncoated surface of a spring, a preheating step of preheating the spring on which the phosphate film has been formed to 70° C. or above and 180° C. or below, an undercoating step of making an epoxy resin powder coating containing 75 wt % or more of zinc adhere to the surface of the spring, an intermediate heating step of heating the epoxy resin powder coating adhered at a temperature of 90° C. or above and 180° C. or below, a topcoating step of making an epoxy polyester resin powder coating adhere to the undercoat film composed of the epoxy resin powder coating, and a baking step of baking both the undercoat film and the epoxy polyester resin powder coating adhered thereto at a temperature of 160° C. or above and 220° C. or below.

Hitherto, one embodiment of the spring with high durability and one embodiment of the method of coating the same in accordance with the present invention have been explained. But, the spring with high durability and the method of coating the same in accordance with the present invention are not limited to the above-described embodiments, but can be practiced in various embodiments in which modifications and improvements capable of being made by any one skilled in the art are made without departing from the spirit and the scope of the present Invention.

<Experiments>

Coil springs were coated with various coating conditions changed. Various experiments of the obtained coil springs were carried out, and the corrosion resistance, etc. were evaluated. Hereinafter, explanations will be made in order.

(1) Effect of Kind of Phosphate in Pretreatment Step and Difference in Curing Condition on Corrosion Resistance

Dual-layer coating composed of an undercoat layer and a topcoat layer was applied on surfaces of two kinds of coil springs on which different phosphate films had been formed previously. First, an iron phosphate film was formed on an uncoated surface of a coil spring made of SUP7 (wire diameter φ 13.9 mm, spring diameter φ 136 mm, load 1.0 to 2.9 (kN)) with the spray method. And a zinc phosphate film was formed on an uncoated surface of a similar coil spring with the same method. The film weight of each phosphate film was about 2.2 g/m², and the average diameter of phosphate crystals was about 3 μm.

Next, both coil springs were placed on a coating line, and heated to 80° C., respectively. Then, an epoxy resin powder coating was made to adhere to the surface of each coil spring using a corona charging coating gun. The epoxy resin powder coating mainly contains “Epikote (trade mark) 1002” (manufactured by JAPAN EPOXY RESINS CO., LTD.) as an epoxy resin, zinc “ARADUR (trade mark) 2844” (manufactured by VANTICO CO.) as a curing agent, and “VESTAGON (trade mark) B1530” (manufactured by Degussa Corporation) as block isocyanate. The content of each material in the epoxy resin powder coating is as follows. Zinc: 80 wt %, curing agent: 0.8 wt %, block isocyanate: 1.0 wt %. And, the epoxy equivalent weight of “Epikote 1002” was about 650. Then, each coil spring to which the epoxy resin powder coating had been made to adhere was heated at 115° C. for 15 minutes.

Next, each coil spring was once cooled to a normal temperature, and an epoxy polyester resin powder coating was made to adhere to the undercoat film composed of the epoxy resin powder coating using a corona charging coating gun. The epoxy polyester resin powder coating mainly contains “Epikote 1003” (manufactured by JAPAN EPOXY RESINS CO., LTD.) as an epoxy resin, “U-PiCA coatGV-250” (manufactured by Japan U-PiCA Company, Ltd.) as a polyester resin, carbon black, and calcium carbonate (trade name “SUN LIGHT” (average particle diameter: 0.51 μm), manufactured by Takehara Kagaku Kogyo Co., Ltd.). The content of each material in the epoxy polyester resin powder coating is as follows. Epoxy resin: 33 wt %, polyester resin: 33 wt %, carbon black: 1.5 wt %, calcium carbonate: 26 wt %. And, the epoxy equivalent weight of “Epikote 1003” was about 720. Then, both coil springs were baked at 185° C. for 20 minutes. The present coating method will be referred to as 2 coating 1.5 baking method (2C1.5B) based on the curing conditions

Dual-layer coating was applied on surfaces of two kinds of coil springs similarly to the preceding method except that the epoxy polyester resin powder coating was made to adhere, without heating after the adhering of the epoxy resin power coating. This coating method will be referred to as 2 coating 1 baking method (2C1B). In every coating method, the thickness of the formed undercoat layer was 60 μm. And the thickness of the topcoat layer was 240 μm.

The coated coil springs were subjected to the corrosion resistance test. The method of the corrosion resistance test is as follows. First, a salt water (NaCl concentration 5%) was sprayed on each coil spring at 35° C. for 21 hours. Next, the coil springs were left for 3 hours in the air, and dried naturally. The cycle of spraying a salt water→drying naturally was carried out five cycles in total. Then, the resultant coil springs were shaken 3000 times under two kinds of conditions of normal temperature and a low temperature of −10° C. The corrosion resistance was evaluated based on values calculated from the formula of [(the number of flaws—the number of rust)/the number of flaws×100]. As the calculated values increase, the number of formation of rust decreases to exhibit that the corrosion resistance is high. The evaluation result is shown in Table 1. In Table 1, the evaluation results of the coil springs to which single-layer coating of only the topcoat layer without any undercoat layer has been applied, are shown together.

Table 1

As shown in Table 1, the dual-layer coating exhibits high corrosion resistance regardless of the coating method and the testing temperature, as compared with the single-layer coating. In particular, the coil springs on which the zinc phosphate films were formed exhibited a high corrosion resistance. In the coil springs on which the zinc phosphate films were formed, the difference in corrosion resistance caused by the coating method was scarcely observed. On the other hand, in the case of the iron phosphate films, the corrosion resistance formed with the 2 coating 1 baking method became slightly higher.

(2) Effect of Difference in Zinc Content in Undercoat Layer on Corrosion Resistance

Dual-layer coating was applied to coil springs with the zinc content in the epoxy resin powder coating composing the undercoat layer changed. Zinc phosphate films were previously formed on surfaces of the coil springs, and the coating method was the 2 coating 1.5 baking method as described in the above (1).

The corrosion resistance test was carried out against the coated coil springs. The corrosion resistance test was the salt spray test according to JIS Z 2371 in which coated surfaces formed on the coil springs were cross-cut and a salt water was sprayed for 2000 hours. The test results are shown in Table 2.

Table 2

As shown in Table 2, when the zinc content was 64 wt % or less, rust was formed. But, when the zinc content is 75 wt % or more, rust was not formed. From these test results, it has been confirmed that in order to obtain a sufficient corrosion resistance, the zinc content in the undercoat layer is needed to be determined to 75 wt % or more.

(3) Effect of Difference in Thickness of Undercoat Layer on Corrosion Resistance

Dual-layer coating was applied to coil springs with the thickness of the undercoat layer changed. Zinc phosphate films were previously formed on surfaces of the coil springs, and the coating method was the 2 coating 1.5 baking method as described in the above (1).

The corrosion resistance test was carried out against the coated coil springs. The corrosion resistance test was the salt spray test according to JIS Z 2371 in which coated surfaces formed on the coil springs were cross-cut and a salt water was sprayed for 2000 hours, similarly to the above-described test. The test results are shown in Table 3.

Table 3

As shown in Table 3, when the thickness of the undercoat layer is 40 μm or more, there was no change in appearance thereof. But, when 40 μm, rust was formed in cross-cut parts, and peeling of about 0 to 2 mm was observed. And when 20 μm, dotted rust was observed in the appearance thereof, rust was formed in cross-cut parts, and peeling of about 2 mm was observed. From these test results, it has been known that it is preferable to determine the thickness of the undercoat layer to 50 μm or more.

(4) Effect of Difference in Resin Component Composing Topcoat Layer on Abrasion Resistance

Coating was applied to a coil spring, similarly to the 2 coating 1.5 baking method (pretreatment: zinc phosphate film) described in the above (1). In the present coating, the thickness of the undercoat layer was 79 μm and the thickness of the topcoat layer was 400 μm. The coated coil spring was partly cut out as a spring of the embodiment 1.

On the other hand, in the coating with the same 2 coating 1.5 baking method, coating of two layers was applied to a coil spring with the coating for forming the topcoat layer and the thickness of each layer changed. Namely, the above-described epoxy polyester resin powder coating was replaced with a coating containing a copolymer of ethylene acryl as a resin component. The thickness of the undercoat layer was 70 μm, and the thickness of the topcoat layer was 380 μm. The coated coil spring was partly cut out as a spring of the comparative example 1.

The abrasion resistance test was carried out against the springs of the above-described embodiment 1 and the comparative example 1 with the HEIDON friction abrasion testing machine (manufactured by Shinto Scientific Co., Ltd.). First, both springs were placed on a bed of the testing machine, and a cylindrical pin (φ 2.2 mm) was placed thereon. The surface roughness (Ra) of the pin was 0.45 μm and the contacting area against the spring was 3.80 mm². The bed on which both springs were placed was stroked in such a direction that the coil expands when full-bumping, while applying a load of 500 g from the upper side of the pin. The stroke rate was 600 mm/minute, and the stroke width was 12 mm. And the abrasion amount was obtained from the difference in film thickness in each spring before and after testing. The results of the abrasion resistance test are shown in Table 4.

Table 4

As shown in Table 4, in the spring of the comparative example 1, when the stroking times are 25,000, the abrasion amount was 180 μm, whereas in the spring of the embodiment 1, when the stroking times are 50,000, that is double of the comparative example 1, the abrasion amount was 90 μm which is half of that of the spring of the comparative example 1. From these test results, it has been confirmed that the spring of the embodiment 1 is excellent in abrasion resistance.

(5) Evaluation of Chipping Resistance with SAICAS Device

Coating was applied to coil springs, similarly to the 2 coating 1.5 baking method (pretreatment: zinc phosphate film) described in the above (1). In the present coating, two kinds of coatings were carried out with the thickness of each layer changed. In one coating, the thickness of the undercoat layer was 72 μm, and the thickness of the topcoat layer was 358 μm. In the other coating, the thickness of the undercoat layer was 85 μm, and the thickness of the topcoat layer was 552 μm. The coated coil springs were partly cut out and subjected to the later-describing tests (Embodiments 2 and 3).

On the other hand, in the same 2 coating 1.5 baking method, coating was applied to coil springs with the coating used for forming the topcoat layer changed. Namely, the above-described epoxy polyester resin powder coating was replaced with a coating containing a copolymer of ethylene acryl as a resin component. In the present coating, two kinds of coatings were carried out with the thickness of each layer changed. In one coating, the thickness of the undercoat layer was 70 μm, and the thickness of the topcoat layer was 400 μm. In the other coating, the thickness of the undercoat layer was 30 μm, and the thickness of the topcoat layer was 470 μm. Parts of the coated coil springs were cut out and subjected to the later-describing tests (Comparative examples 2 and 3).

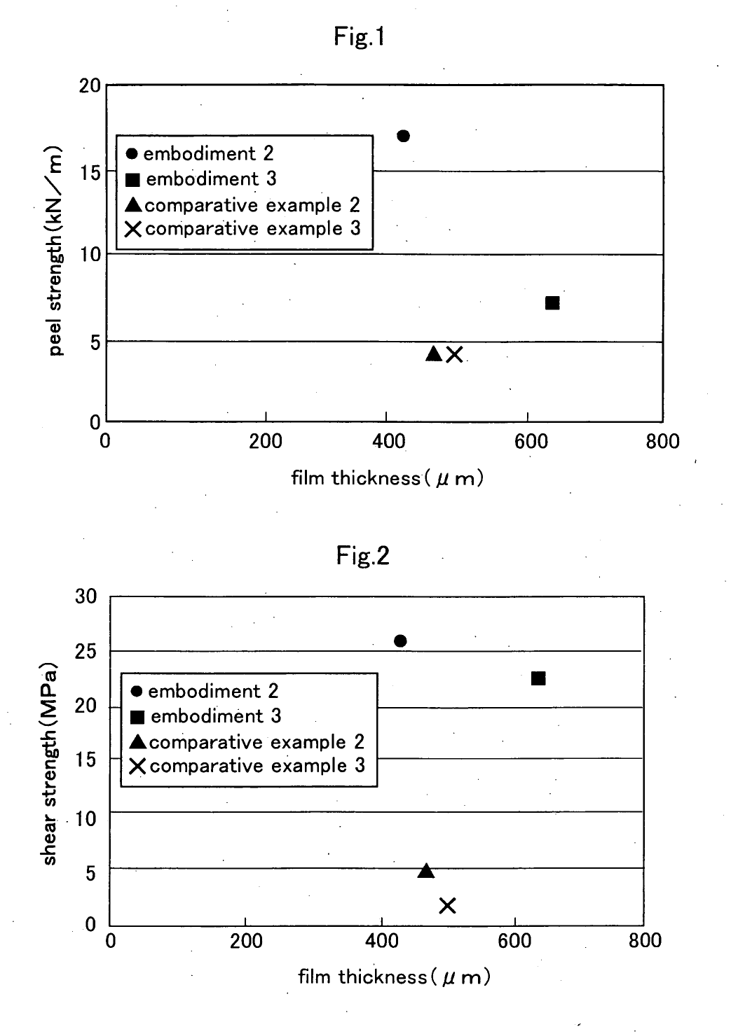

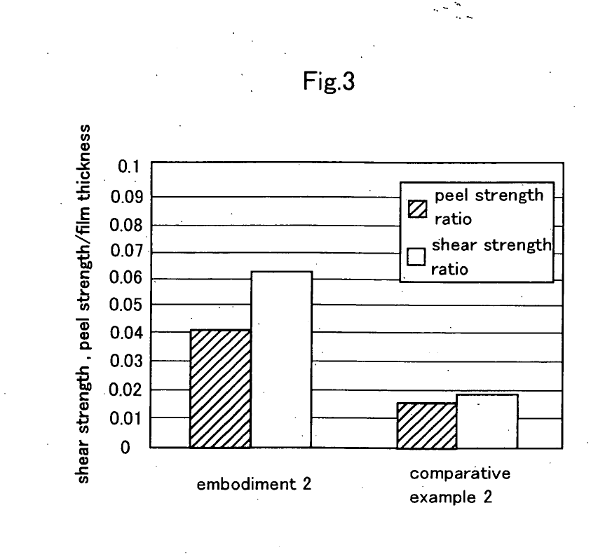

The above-described four kinds of samples were subjected to the cutting test using the SAICAS device (┌SAICAS BN-1┘ manufactured by DAIPLA WINTES Co., Ltd.) to measure the peel strength and the shear strength of films. It can be considered that as the peel strength and the shear strength of the films increase, the chipping resistance increases. The results of the cutting test are shown in FIGS. 1 to 3. FIG. 1 shows the relation between the film thickness and the peel strength. FIG. 2 shows the relation between the film thickness and the shear strength. FIG. 3 shows the peel strength and the shear strength per unit film thickness in the embodiment 2 and the comparative example 2.

As shown in FIG. 1, in the embodiments 2 and 3, the peel strengths of the coating films were higher, as compared with the comparative examples 2 and 3. Namely, it is clear that in the embodiments 2 and 3, the adhesion of the coating films is high. And, as shown in FIG. 2, in the embodiments 2 and 3, the sear strength of the coating films were high, as compared with the comparative examples 2 and 3. Namely, it is clear that in the embodiments 2 and 3, the strength of the coating films is high. Furthermore, it is clear from FIG. 3 that the peel strength and the sear strength per unit film thickness of the embodiment 2 are higher. From these results, it has been confirmed that the coating films coated by the coating method in accordance with the present invention exhibit high adhesion and high strength, and are excellent in chipping resistance.

### INDUSTRIAL APPLICABILITY

The springs with high durability in accordance with the present invention are useful in motor vehicles, rail road trains, etc., and, in particular, suitable for suspension springs for use in motor vehicles.

TABLE 1

| | pretreatment | | | | | |
|---|---|---|---|---|---|---|
| | iron phosphate films | | | zinc phosphate films | | |
| coating method | 2C1B | 2C1.5B | only the | 2C1B | 2C1.5B | only the |
| | | | topcoat | | | topcoat |
| | | | layer | | | layer |
| normal temperature | 91 | 88 | 55 | 95 | 97 | 80 |
| low temperature | 97 | 88 | 78 | 100 | 100 | 77 |
| (−10° C.) | | | | | | |

TABLE 2

| | zinc content (wt %) | | | | | |
|---|---|---|---|---|---|---|
| | 32 | 48 | 64 | 75 | 80 | 96 |
| whether or not rust is | formed | formed | formed | none | none | none |
| formed | | | | | | |

TABLE 3

| | thickness of undercoat layer (μm) | | | | | |
|---|---|---|---|---|---|---|
| | 20 | 40 | 50 | 60 | 70 | 80 |
| appearance | dotted | no | no | no | no | no |
| | rust | change | change | change | change | change |
| condition of | rust | rust | slight | no | no | no |
| cross-cut parts | | | rust | change | change | change |
| peeling width | 2 | 0˜2 | 0 | 0 | 0 | 0 |
| (mm) | | | | | | |

TABLE 4

| | film thickness(μm) | | abrasion | stroking |
|---|---|---|---|---|
| | before | after | amount | times |
| | testing | testing | (μm) | (times) |
| spring of the embodiment 1 | 479 | 389 | 90 | 50000 |
| spring of the comparative | 450 | 270 | 180 | 25000 |
| example 1 | | | | |

1. A spring with high durability coated with two layers consisting of an undercoat layer which is composed of an epoxy resin powder coating containing 75 wt % or more of zinc, and a topcoat layer which is formed on said undercoat layer and composed of an epoxy polyester resin powder coating.

2. A spring with high durability as claimed in claim 1, wherein a phosphate film is formed under said undercoat layer.

3. A spring with high durability as claimed in claim 1, wherein said undercoat layer has a thickness of 50 g m or more.

4. A spring with high durability as claimed in claim 1, wherein said topcoat layer has a thickness of 200 g m or more.

5. A method of coating a spring with high durability, which comprises:
an undercoating step of making an epoxy resin powder coating which contains 75 wt % or more of zinc adhere to a surface of said spring;
a topcoating step of making an epoxy polyester resin powder coating adhere to an undercoat film composed of said epoxy resin powder coating; and
a baking step of baking said undercoat film and said epoxy polyester resin powder coating adhered to said undercoat film.

6. A method of coating a spring with high durability as claimed in claim 5, further comprising an intermediate heating step of heating said adhered epoxy resin powder coating to form a film in a half-cured state, between said undercoating step and said topcoating step.

7. A method of coating a spring with high durability as claimed in claim 5, further comprising:
a preheating step of preheating said spring to 70° C. or above and 180° C. or below, before said undercoating step, and
an intermediate heating step of heating said adhered epoxy resin powder coating at a temperature of 90° C. or above and 180° C. or below, between said undercoating step and said topcoating step, wherein
said baking step is carried out at a temperature of 160° C. or above and 220° C. or below.

8. A method of coating a-spring with high durability as claimed in claim 5, further comprising a pretreating step of previously forming a phosphate film on an uncoated surface of said spring before said undercoating step.

9. A method of coating a spring with high durability as claimed in claim 5, wherein said epoxy resin powder coating includes at least one of bisphenol A type epoxy resin, bisphenol F type epoxy resin and crystalline epoxy resin.

10. A method of coating a spring with high durability as claimed in claim 5, wherein said epoxy resin powder coating contains block isocyanate.

11. A method of coating a spring with high durability as claimed in claim 10, wherein the content of said block isocyanate is 0.2 wt % or more and 5 wt % or less to 100 wt % of the total weight of said epoxy resin powder coating.

12. A method of coating a spring with high durability as claimed in claim 5, wherein said epoxy polyester resin powder coating includes at least one of bisphenol A type epoxy resin, bisphenol F type epoxy resin and crystalline epoxy resin, and polyester resin.

13. A method of coating a spring with high durability as claimed in claim 5, wherein said epoxy polyester resin powder coating includes an extender pigment.
